(19) United States
(12) Patent Application Publication
(10) Pub. No.: US 2019/0017533 A1
(43) Pub. Date: Jan. 17, 2019

(54) BOLT WITH BRAKED UNSCREWING

(71) Applicant: RDO ALPHA, Vireux Molhain (FR)

(72) Inventor: Carlos RODRIGUES DE OLIVEIRA, Givet (FR)

(73) Assignee: RDO ALPHA, Vireux Molhain (FR)

(21) Appl. No.: 15/745,128

(22) PCT Filed: Jul. 22, 2016
(86) PCT No.: PCT/FR2016/051914

§ 371 Date: Jan. 15, 2018

(30) Foreign Application Priority Data
Jul. 22, 2015 (FR) 1556929

(51) Int. Cl. F16B 39/284

(52) U.S. Cl. CPC F16B 39/284

(57) ABSTRACT

A bolt with braked unscrewing consists of a screw and a nut. The screw or nut includes, in the axial direction, at least three stepped portions of continuous thread, namely an introduction portion for introducing the screw into the nut, a braking portion and an intermediate portion connecting the introduction portion to the braking portion. The braking portion has a thread diameter that is constant and different from the thread diameter of the introduction portion.

The invention relates to the field of bolts and screws. It relates more particularly to a bolt with braked unscrewing.

A bolt is an assembly member composed of a nut and a screw that can alternatively be screwed or unscrewed along a continuous thread according to a particular need.

They are generally made of metal or metal alloy such as steel, stainless steel, aluminum, platinum, etc. but may be made of any other material meeting strength criteria.

The bolts act as frets whose elasticity makes it possible to maintain the tightness of the parts, despite the influence of external factors such as mechanical actions, vibrations or temperature rises. One or more washers disposed on either side of the parts make it possible to better distribute the compressive stress, to take up the possible matting of the surfaces and/or to protect the substrate from unwanted distortions. An additional nut (lock nut) can brake the assembly and prevent it from loosening.

Other devices make it possible to prevent loosening of the nut on the screw thread, by mechanical stop (foldable washers, drilling and introduction of a wire in the aviation field, pinning, castellated nuts), or by effect of the tightening in particular the brake washers that are split and elastic, waved, toothed.

The nut itself may have braking means intended for preventing accidental loosening by vibration. Such means are for example a slot allowing flattening which decreases the diameter (slot in the axis) or decreases the pitch (slot perpendicular to the axis), or nuts provided with a polymer ring, they are also called self-locking nuts. There are also gluing systems using anaerobic adhesives, removable by heating or brute force.

In particular the document U.S. Pat. No. 2,190,174 discloses a nut comprising as a brake means, a few pitches of a thread of nominal diameter identical to the rest of the thread, but with higher threads, so that the crests of these few threads extend up to the bottom of the threads of the screw that is screwed into the nut. This solution allows locking of the nut, and at the same time a tightness of the bolt once mounted, and is used in particular for gas pipes. However, the crest of the thread of the nut presses on the bottom of the thread of the screw, and takes some material away. This material then builds up between the screw and the nut, and causes seizure. Disassembly then becomes very difficult or even impossible.

According to the invention, the thread diameter will refer to the external diameter of the screw (of the crest of the threads) or the diameter at the bottom of the thread of the nut.

The present invention therefore aims to propose new means in order to answer the disadvantages of the prior art. It is more particularly proposing a bolt with braked unscrewing consisting of two elements, a screw and a nut, one of which comprises in the axial direction at least three stepped portions of continuous thread, namely an introduction portion for introducing the screw into the nut, a braking portion and an intermediate portion connecting the introduction portion to the braking portion, characterized in that said braking portion has a thread diameter that is constant and different from the thread diameter of the introduction portion, especially a larger thread diameter if it is the screw, and a smaller one if it is the nut.

Thanks to these arrangements, the screwing as well as the unscrewing requires more effort as soon as it comes to the braking portion, and so a bolt with braked unscrewing is obtained.

According to other features:
The continuous thread may have the same pitch and the same height along the introduction portion, the intermediate portion and the braking portion, thus allowing plane contact between the threads of the screw and the nut, avoiding the contact at the level of the crest of the thread, which makes it possible to avoid material to be pulled off and seizure,
the introduction portion can represent at least one thread pitch, making it possible to ensure the orientation and the engagement of the screw with the nut before arriving to the braking portion,
the braking portion can represent at least one thread pitch, making it possible to ensure a minimum of braking, in particular a length of at least one third of the axial length of the nut, allowing reliable and efficient braking,
the ratio between the thread diameter of the introduction portion and the thread diameter of the braking part for a screw, its inverse for a nut, can be between 0.92 and 0.96, a value that is too close to 1 entailing the risk of not braking for certain screw-nut couples, and a value too much under 0.92 entailing the risk of jamming or damage to the nut during screwing.

The invention also relates to a screw characterized in that the thread diameter of its introduction portion is smaller than the thread diameter of its braking portion.

The invention also relates to a nut characterized in that the thread diameter of its introduction portion is greater than the thread diameter of its braking portion.

The invention finally relates to a manufacturing method of a nut characterized in that:
a nut of constant thread diameter is introduced into a die having a first cylindrical portion of a section substantially equal to the section of the nut, a second cylindrical portion homothetic to the first cylindrical portion, of smaller diameter and provided in its end far from the first cylindrical portion of a bottom, and an intermediate portion connecting the first cylindrical portion to the second cylindrical portion continuously,
an extrusion is performed by cold stamping or press on one of the tops of the nut so as to reduce, over a portion of its axial length, its transverse dimensions and the internal diameter of its threaded hole.

According to a preferred embodiment of the invention, the intermediate portion is inclined relative to the cylinder axis by an angle at most equal to 20°.

Other features and advantages of the present invention will appear on reading the following detailed description relating to an exemplary embodiment given by way of indication and not limitation.

The understanding of this description will be facilitated with references to the attached drawings, in which:

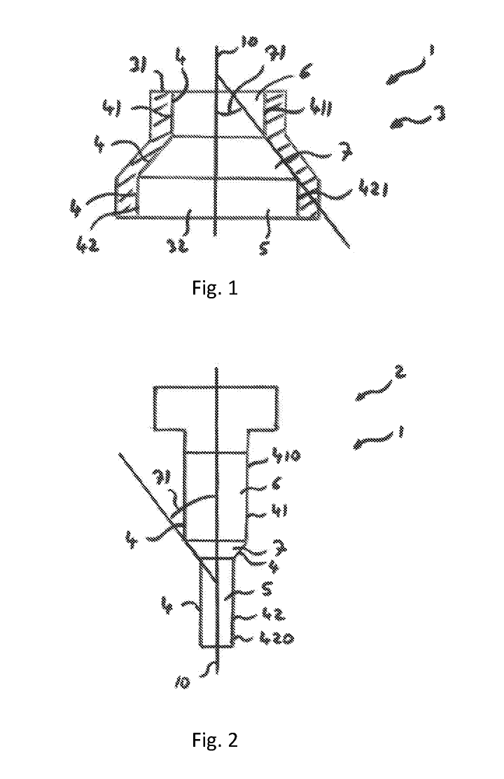

FIG. 1 schematically represents a sectional view of a nut according to the invention;

FIG. 2 schematically represents a sectional view of a screw according to the invention;

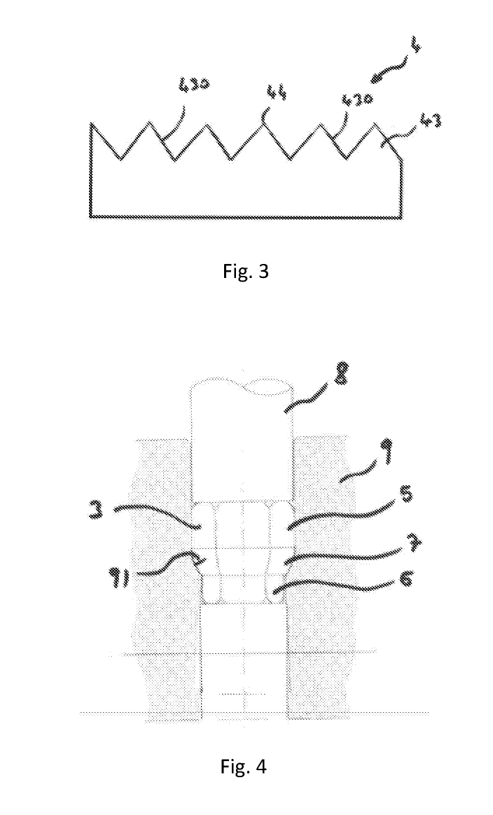

FIG. 3 schematically represents a sectional view of a detail of a thread according to the invention;

FIG. 4 schematically represents a view of a method according to the invention;

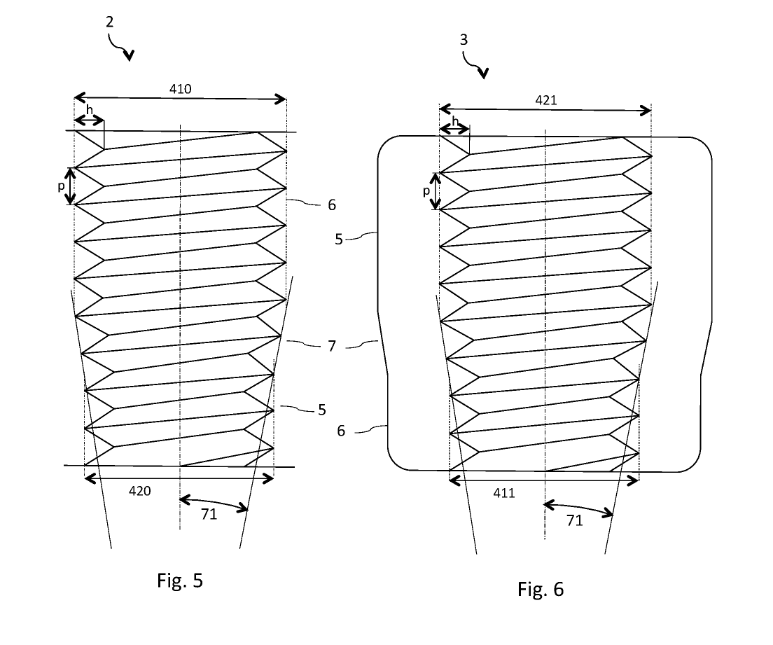

FIG. 5 schematically represents a partial detailed sectional view of a screw according to the invention, the head (not shown) of the screw being located above this representation;

FIG. 6 schematically represents a detailed sectional view of a nut according to the invention.

Thus, as shown in FIGS. 1 to 6, the present invention firstly relates to a bolt 1 with braked unscrewing consisting of a screw 2 and a standard nut or a nut 3 and a standard screw, said screw 2 or nut 3 comprising in their axial length 10 at least three stepped portions of continuous thread 4, namely an introduction portion 5 for introducing the screw 2 into the nut 3, a braking portion 6 and an intermediate portion 7 connecting the introduction portion 5 to the braking portion 6.

This bolt 1 is characterized in that said braking portion 6 has a thread diameter 41 constant and different from the thread diameter 42 of the introduction portion 5.

According to the invention, the bolt 1 comprises braking means. These braking means are represented by the thread diameters 41 that are constant over the entire length of the braking portion, and on its circumference, and higher for a screw 2 and lower for a nut 3 than the thread diameter 42 of the introduction portion 5.

Continuous thread means that screwing and unscrewing can be continuous over the entire length of the available thread. The stepping of the three portions means that they follow one after the other in length along the axis 10.

Thanks to the bolt of the invention, it is easy to introduce the screw in the nut and then when screwing in the intermediate portion 7, it is necessary to produce an increasing force in order to screw. This force then becomes constant over the entire chosen length of screwing on the braking portion 6.

It is possible to obtain a press fit of the two parts of the bolt 1.

According to the configuration of the bolt 1 according to the invention, the length of the braking portion 6 may be at least one third of the length of the nut along the axis 10.

It takes an equivalent effort to unscrew the nut on the braking portion 6.

The braking means operate due to the relative elasticity of the material of the nut.

The bolt 1 according to the invention is ecological since its design uses only one material, usually a metal or metal alloy such as steel.

The braking means of the invention are effective against vibrations and securing of moving mechanics such as for example in applications of turbine, in the railway field, the naval field, aeronautics, etc.

According to the invention, if the screw 2 comprises the braking means, a standard nut, that is to say without braking means, can be used.

Conversely, if the nut 3 comprises the braking means, a standard screw, that is to say without braking means, can be used.

Advantageously, the intermediate portion 7 has a shape of a thread following a truncated cone of revolution with a top half-angle 71 between 1° and 70°. To put it differently, the thread diameter of the intermediate portion 7 varies continuously from the thread diameter 42 of the introduction portion 5 to the thread diameter 41 of the braking portion 6.

Angles up to 20° are by far the most advantageous so that the intermediate portion 7 serves as a guide to the screw entering into the nut, without causing too much friction which would cause a pulling off of material, and thus seizure. A preferred angle is around 15°.

A shape equivalent to a truncated cone of revolution allows a regular increase of the effort to be made for the screwing in this portion.

According to a particular embodiment of the invention, the ratio of the thread diameter of the portion having the smallest thread diameter to the thread diameter of the portion of the bolt having the highest thread diameter, being the smallest divided by the largest, is between 0.92 and 0.96.

The value of this ratio within the bolt varies according to the choice of materials, for example if the material is a steel that is heat-treated or not, or according to its tolerance class or the value of the operating clearances.

The lower the value of this ratio, the greater the braking but it must not be too low, otherwise it could be that with the efforts usually applied by a screwdriver, a screw could no longer enter into the braking portion 6 of the nut 3, or that its braking portion 6 can no longer enter into a nut, or that its introduction causes a distortion of the nut beyond the elastic range, so that it could not return to its original form. On the other hand, a too low ratio entails the risk that according to the involved clearances, and according to the reality of the dimensions of the screw and the nut within their tolerance range, certain assemblies are not braked at all any more.

Preferably, said thread 4 has a profile 43 in the shape of a triangle or trapezium, its top 44 may also be rounded.

A profile in the form of a triangle or trapezium makes it possible to distribute the braking force over a maximum surface of the flanks 430 of the thread 4 in a uniform manner and thus makes it possible to prevent deteriorations such as seizure and pullout. There is a hardening and a surface settlement. Thus, it is possible to screw and unscrew the nut 3 on the screw 2 on the braking portion 6 over its entire length. Lubrication may be applied to the thread of the nut in order to facilitate screwing.

According to the invention, the thread has an identical pitch p from the introduction portion 5, along the intermediate portion 7, and in the braking portion 6. The thread also has a height h identical along the three portions.

This characteristic makes it possible, in particular for screw threads that are rounded or cut at their top, to ensure that the contact between the screw and the nut is always on the faces of the thread, and never between the crest of the thread of the screw and the bottom of the thread of the nut.

It is well known in mechanics that the absolute identity of two dimensions does not exist, because of manufacturing tolerances or deformations experienced by the screws and/or the nuts.

Consequently, the term “identical” should be understood within the scope of the present invention as close enough to effectively achieve contact on the faces of the thread and not on their crests.

This advantage is particularly important at the braking portion 6, where the friction forces between the screw and the nut become important, and where the surface contact makes it possible to avoid any pullout of material, and thus significantly reduces the risk of seizure.

When introducing a screw into a nut at the braking portion 6, the thread of the screw is, at least in some places, of a larger diameter than the thread of the nut. In order to go through, the screw must push the nut, which is very slightly deformed in the elastic range and can return fully or partly to its original shape. This is true in the screwing phase as well as the unscrewing phase, which gives its great stability to this assembly, which does not loosen under the effect of vibration in particular.

The invention also relates to a screw 2 with braked unscrewing comprising in the axial length 10 at least three stepped portions of continuous thread, namely an introduction portion 5 to introduce the screw 2 into the nut 3, a braking portion 6 and an intermediate portion 7 connecting the introduction portion 5 to the braking portion 6.

This screw 2 is characterized in that the thread diameter 420 of the introduction portion 5 is smaller than the thread diameter 410 of the braking portion 6, the thread diameter 410 being of constant value over the entire length of the braking portion 6 as well as over its entire circumference, the thread being identical in pitch p and in height h over the entire length of the introduction portion 5, intermediate portion 7 and braking portion 6.

This difference between the thread diameters 420 and 410 makes it possible to obtain the braking effect during screwing.

Advantageously, the introduction portion 5 of the screw 2 represents at least one thread pitch p.

A pitch p of a thread 4 in the introduction portion 5 is useful for the effective introduction of the screw 2 into a nut.

Preferably, the braking portion 6 of the screw 2 represents at least one thread pitch p.

A pitch p of thread 4 is useful in the braking portion 6 of the screw 2 to obtain a braking effect.

The screw 2 can be obtained for example by rolling, or by machining.

According to another embodiment, the screw 2 is tri-lobed, triangular type.

The screw 2 can thus cause during the first screwing a triangular deformation of a standard nut. The tri-lobed shape reduces the forces during screwing. The screw 2 is thus more resistant against loosening, and has a better resistance to vibrations.

According to a particular embodiment, the ratio between the thread diameter 420 of the introduction portion 5 of the screw 2 and the thread diameter 410 of the braking portion 6 of the screw 2 is between 0.96 and 0.92.

The value of this ratio within a screw varies according to the choice of materials, for example if the material is a steel that is heat-treated or not. The lower the value of this ratio, the greater the braking, with the reservations and limits mentioned above.

A screw 2 according to the invention may be manufactured by machining from a larger thread diameter than that for threading the corresponding standard screw. One can also take a standard screw, and apply an additive manufacturing process.

The invention also relates to a nut 3 with braked unscrewing comprising in the axial length 10 at least three stepped portions of continuous thread, namely an introduction portion 5 for introducing a screw into the nut 3, a braking portion 6 and an intermediate portion 7 connecting the introduction portion 5 to the braking portion 6.

This nut 3 is characterized in that the thread diameter 421 of the introduction portion 5 is greater than the thread diameter 411 of the braking portion 6, the thread diameter 411 being of constant value over the entire length of the braking portion 6, as well as over its entire circumference.

This difference between the thread diameters 421 and 411 makes it possible to obtain the braking effect during screwing.

According to yet another embodiment, the introduction portion 5 of the nut 3 represents at least one thread pitch p.

A pitch p of thread 4 in the introduction portion 5 is useful for the effective introduction of a screw into the nut 3.

According to a preferred embodiment, the braking portion 6 of the nut 3 represents at least one thread pitch p.

A pitch p of thread 4 is useful in the braking portion 6 of the nut 3 to obtain a braking effect.

According to a particular embodiment, the ratio between the thread diameter 411 of the braking portion 6 of the nut 3 and the thread diameter 421 of the introduction portion 5 of the nut 3 is between 0.96. and 0.92.

The value of this ratio within the nut 3 varies according to the choice of materials, for example if the material is a steel that is heat-treated or not.

The lower the value of this ratio, the greater the braking, with the reservations and limits mentioned above.

All the advantages of the invention which apply to the bolt 1, also apply to the screw 2 and the nut 3, when they are considered individually and separately.

The invention finally relates to a method of manufacturing a nut 3 as represented in FIG. 4.

This method is characterized in that:
a nut of constant thread diameter is introduced into a die having a first cylindrical portion of section substantially equal to the section of the nut, a second cylindrical portion homothetic to the first cylindrical portion, of smaller diameter and provided in its end far from the first cylindrical portion with a bottom, and an intermediate portion connecting the first cylindrical portion to the second cylindrical portion continuously,
an extrusion is performed by cold stamping or press on one of the tops 31 of the nut so as to reduce, over a portion of its axial length 10, its transverse dimensions and the internal thread diameter 421 of its threaded hole 32.

It is the extrusion of the outer diameter of the nut 3 which causes a reduction of the internal thread diameter 421 of the threaded hole 32. The degree of extrusion is directly proportional to the reduction in diameter. The thread diameter 421 can therefore become the thread diameter 411.

This extrusion can be done on a chosen length on the nut 3.

There is no weakening applied to the nut 3, it keeps all its mechanical strength, which can even be slightly improved because of work hardening.

The advantage of using an extrusion by cold stamping or press to obtain the nut 3 is the work hardening of the reduced part. The braking effect will then be more important. The extrusion can be free or contained in a die.

FIG. 4 shows an example of extrusion contained in a die 9 in which a standard nut is extruded according to the method of the invention to obtain a nut 3. A punch 8 makes the extrusion of the nut possible in the die 9.

In the case of using an extrusion contained in a die, such as the die 9, the radius 91 of the concavity at the entrance of the die 9 must meet the standards of the person skilled in the art.

But in order to obtain the nut 3, it is entirely possible to use other methods. It is for example the use of forging, machining, threading with a stepped thread, special heat treatments.

The bolt 1 is not limited in its external shape. The head of the screw 2 can therefore have the usual hexagonal shape. Similarly, the nut 3 can be a cap nut.

1-9. (canceled)

10. A bolt with braked unscrewing consisting of a screw and a nut, said screw or said nut comprising in the axial direction at least three stepped portions of continuous thread, including an introduction portion for introducing the screw into the nut, a braking portion and an intermediate portion connecting the introduction portion to the braking portion, wherein said braking portion has a thread diameter that is constant and larger if it belongs to the screw, smaller if it belongs to the nut, than the thread diameter of the introduction portion.

11. The bolt according to claim 10 wherein the continuous thread has the same pitch and the same height along the introduction portion, the intermediate portion and the braking portion.

12. The bolt according to claim 10, wherein the introduction portion represents at least one pitch of threading.

13. The bolt according to claim 10, wherein the braking portion represents at least one pitch of threading, in particular the length of the braking portion is at least one third of the axial length of the nut.

14. The bolt according to claim 10, wherein the ratio between the thread diameter of the introduction portion and the thread diameter of the braking portion for a screw, its inverse for a nut, is between 0.92 and 0.96.

15. A screw intended for collaborating with a nut to form the bolt according to claim 10, wherein said screw comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and larger than the thread diameter of the introduction portion, and said continuous thread having the same pitch and the same height along the introduction portion, the intermediate portion and the braking portion.

16. A nut intended for collaborating with a screw to form the bolt according to claim 10, wherein said nut comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and smaller than the thread diameter of the introduction portion, and said continuous thread having the same pitch and the same height along the introduction portion, the intermediate portion and the braking portion.

17. A manufacturing method of the nut according to claim 16, said method comprising the steps of:
introducing a nut of constant thread diameter into a die having a first cylindrical portion of section substantially equal to the section of the nut, a second cylindrical portion homothetic to the first cylindrical portion, of smaller diameter and provided in its end far from the first cylindrical portion of a bottom, and an intermediate portion connecting the first cylindrical portion to the second cylindrical portion continuously; and
performing an extrusion by cold stamping or press on one of the tops of the nut in order to force the nut into the second cylindrical portion so as to reduce, over a portion of its axial length, its transverse dimensions as well as its thread diameter.

18. The manufacturing method according to claim 17, wherein the intermediate portion is inclined relative to the axis of the cylinders by an angle at most equal to 20°.

19. The bolt according to claim 11, wherein the introduction portion represents at least one pitch of threading.

20. The bolt according to claim 11, wherein the braking portion represents at least one pitch of threading, in particular the length of the braking portion is at least one third of the axial length of the nut.

21. The bolt according to claim 12, wherein the braking portion represents at least one pitch of threading, in particular the length of the braking portion is at least one third of the axial length of the nut.

22. The bolt according to claim 11, wherein the ratio between the thread diameter of the introduction portion and the thread diameter of the braking portion for a screw, its inverse for a nut, is between 0.92 and 0.96.

23. The bolt according to claim 12, wherein the ratio between the thread diameter of the introduction portion and the thread diameter of the braking portion for a screw, its inverse for a nut, is between 0.92 and 0.96.

24. The bolt according to claim 13, wherein the ratio between the thread diameter of the introduction portion and the thread diameter of the braking portion for a screw, its inverse for a nut, is between 0.92 and 0.96.

25. A screw intended for collaborating with a nut to form a bolt according to claim 11, wherein said screw comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and larger than the thread diameter of the introduction portion, and said continuous thread having the same pitch and the same height along the introduction portion, the intermediate portion and the braking portion.

26. A screw intended for collaborating with a nut to form a bolt according to claim 12, wherein said screw comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and larger than the thread diameter of the introduction portion, and said continuous thread having the same pitch and the same height along the introduction portion, the intermediate portion and the braking portion.

27. A screw intended for collaborating with a nut to form a bolt according to claim 13, wherein said screw comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and larger than the thread diameter of the introduction portion, and said continuous thread having the same pitch and the same height along the introduction portion, the intermediate portion and the braking portion.

28. A screw intended for collaborating with a nut to form the bolt according to claim 14, wherein said screw comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and larger than the thread diameter of the introduction portion, and said continuous thread having the same pitch and the same height along the introduction portion, the intermediate portion and the braking portion.

29. A nut intended for collaborating with a screw to form the bolt according to claim 11, wherein said nut comprises in the axial direction at least three stepped portions of continuous thread, namely an introduction portion for introducing the screw into the nut, a braking portion and an intermediate portion connecting the introduction portion to the braking portion, said braking portion having a thread diameter that is constant and smaller than the thread diameter of the introduction portion, and said continuous thread having the same pitch and the same height along the introduction portion, the intermediate portion and the braking portion.
